(19) United States
(12) Patent Application Publication
(10) Pub. No.: US 2003/0123650 A1
(43) Pub. Date: Jul. 3, 2003

(54) Simple adaptive hybrid circuit

(76) Inventor: Feng Ouyang, Holmdel, NJ (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/328,164

(22) Filed: Dec. 26, 2002

Related U.S. Application Data
(60) Provisional application No. 60/344,604, filed on Dec. 26, 2001.

(51) Int. Cl. H04M 9/08

(52) U.S. Cl. 379/406.01

(57) ABSTRACT

A method and apparatus for removing an echo in a receiver of a full-duplex communication by adjusting the relative gain between the hybrid path and the received signal path, where the transfer function of the load coupling circuit is emulated and then the transmitted signal is subtracted from the combined signal and in another method and apparatus, by employing a digital block for making the hybrid gain setting decision by evaluating the hybrid performance where the total received power, which is the sum of the true received power and the power of the residual echo is measured; such an evaluation results in evaluating each possible hybrid gain setting and deciding on the setting that yields the lowest residual echo power. traditional hybrid circuit may be made adaptive to line conditions by varying its relative gain to the input signal.

### CROSS REFERENCE TO RELATED APPLICATIONS

Priority is claimed based on U.S. Provisional Application No. 60/344,604 entitled “A Simple Adaptive Hybrid Circuit” filed Dec. 26, 2001.

### FIELD OF THE INVENTION

The present invention relates generally to electronic circuits, and particularly to the design of hybrid circuits for analog front-end equipments.

### BACKGROUND OF THE INVENTION

With the advent of the Internet and the demand for high-bandwidth electronic communication systems arising out of the consumer demand for information, interactive gaming and electronic entertainment such as video on-demand, there has been a need for reliable and affordable high bandwidth mediums for facilitating such high-bandwidth data transmissions between service providers and their customers. An existing medium involves using already existing copper wire telephone systems (plain old telephone system or POTS) infrastructure. In adapting POTS telephone lines to carry data at high-bandwidth or ‘broadband’ data rates, a number of Digital Subscriber Line (DSL) standards and protocols have been proposed such as VDSL, SHDSL, RADSL and ADSL. The conventional analog telephone system uses the same pair of wires to transmit and receive data, therefore, some means must be employed to separate the strong near-end transmitted signal from the far-end received weaker signal. Modems used in xDSL systems usually provide circuits to separate the received signal from the transmitted signal. Such circuits are referred to as hybrid circuits. Hybrid circuits may also be used to combine transmitted and received signals into a single communication path or to separate a single communication path into separate transmitted and received signals. Hybrid circuits are also often used in both voice and data telephony for coupling a two conductor telephone line, which provides bidirectional communication, to two unidirectional trunk lines, one of which carries the transmitted signal, the other of which carries the received signal. Hybrid circuits typically rely on specially wound transformers to separate or combine the transmit and receive signals. The windings are phased so as to couple the desired signals in phase, but to couple the undesired signals out of phase, thereby, passing the desired signals and canceling the undesired signals.

When full-duplex data communication is conducted on a single pair of conductors, the strong near-end transmitted signal must be separated from the far-end, weaker received signal, otherwise, the received signal becomes corrupted. A conventional hybrid circuit, which is an analog filter, is employed to match the response of the echo path. By sending the transmitted signal through the hybrid circuit, an echo is simulated, which is then subtracted from the received signal (which contains the echo). The characteristics of the echo, however, depend on the transmission line configuration and loading conditions and, therefore, it is difficult or impractical to design a fixed response hybrid circuit that is optimal under all deployment situations.

Better results can be achieved by using an adaptive hybrid circuit that adapts to those line conditions. It changes its response to match the particular echo path in operation, such a circuit is usually complicated and its initial training is difficult.

### SUMMARY OF THE INVENTION

The present invention overcomes these and other drawbacks by implementing a method of adapting the hybrid circuit operation to the echo path. One embodiment of the invention adjusts the relative gain between a hybrid path and a received signal path.

Embodiments of the present invention also employ a digital block for making a hybrid gain setting decision. For example, evaluating a hybrid performance by measuring total received power (e.g. the sum of a true received power and a power of the residual echo) may result in a determination of a hybrid gain setting that yields the lowest residual echo power.

The current invention may implemented on the International Telecommunications Union (ITU) standard G.992.2 (SHDSL) modem. The invention may also be used in other modem implementations.

Another embodiment of the adaptive hybrid circuit, as described above, achieves 6 dB of additional echo rejection, compared with a standard non-adaptive hybrid circuit. This invention maybe used in G.SHDSL, HDSL2, and all other products using the GlobespanVirata Orion™ AFE. Other embodiments may also exist.

### BRIEF DESCRIPTION OF THE DRAWINGS

The present invention can be understood more completely by reading the following Detailed Description of the Invention, in conjunction with the accompanying drawings, in which:

FIG. 1 is a circuit diagram illustrating Analog Front End (AFE) with adaptive hybrid gain circuit according to an embodiment of the invention.

FIG. 2 is a diagram illustrating adaptation of a Hybrid Gain according to an embodiment of the invention.

FIG. 3 is a flow chart illustrating adaptation of a Hybrid Gain according to an embodiment of the invention.

FIG. 4 is a block diagram illustrating the digital adaptation of the Hybrid Gain according to an embodiment of the invention.

### DETAILED DESCRIPTION OF THE INVENTION

The following description is intended to convey a thorough understanding of the invention by providing a number of specific embodiments and details involving the reduction or cancellation of crosstalk. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

When full-duplex data communication is conducted on a single pair of conductors, a portion of the transmitted signal enters the receive path, this signal is an echo signal which is undesirable and needs to be removed from the composite received signal in order to get a corrected received signal which closely approximates the true signal transmitted from the remote end. Such correction is generally accomplished using a controller that uses an algebraic combining unit for algebraically subtracting the echo estimate signal from at least one echo canceller and an output signal.

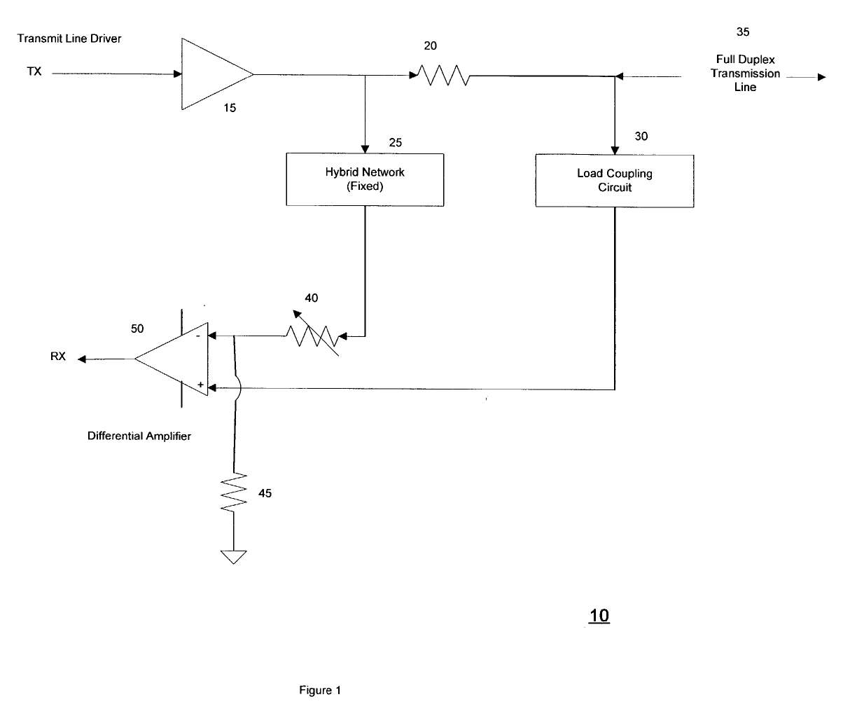

Embodiments of the present invention are directed to significantly reducing or removing the echo generated due to the use of the same two-wire telephone line for both transmitting and receiving signals. One embodiment of the present invention is directed to a method and apparatus used in canceling echo from a received signal with the aid of FIG. 1. FIG. 1 is a block diagram of an adaptive hybrid circuit 10, which includes a transmit line driver 15 to provide differential transmit signal for a line operative to communicate with a telecommunications apparatus in a far-end location over a full duplex transmission line 35. Adaptive hybrid circuit 10 may also comprise a fixed hybrid network 25, which maybe a conventional hybrid circuit, a load coupling circuit 30, adjustable line impedance 40 and a subtractor 50.

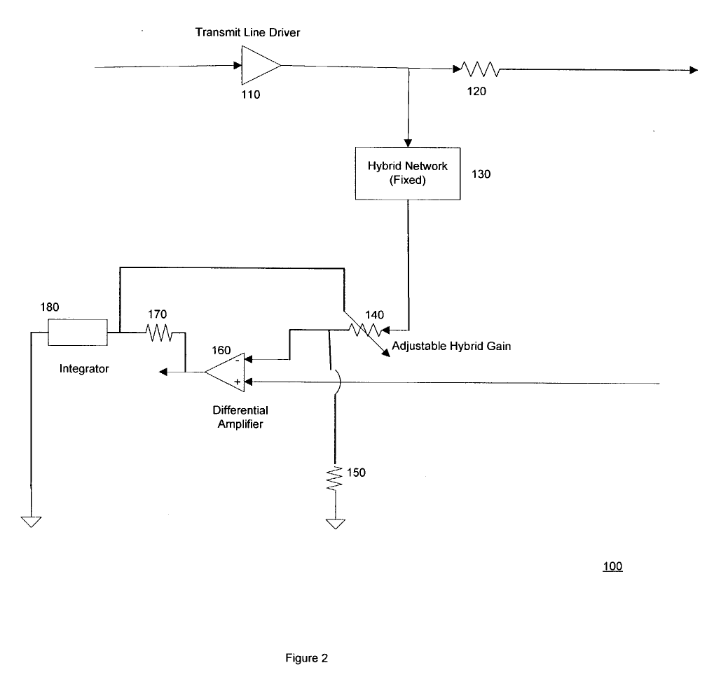

According to another embodiment of the present invention and in reference to FIG. 2, the method and apparatus for removing the echo in an analog front end, includes the adaptive circuit 100, which may comprise a transmit line driver 110 that may provide differential transmit signal for a line operative to communicate with a telecommunications apparatus in a far-end location over a full duplex transmission line. Adaptive hybrid circuit 100 may also comprise a fixed hybrid network 130, which may emulate a transfer function of a load coupling circuit. Adaptive hybrid circuit 100 may also comprise variable line impedance 140, which enables the total average power (i.e. the combined received power and the residual echo of the transmitted power) to be adjustable. Adaptive hybrid circuit 100 may also comprise a differential amplifier 160, which may subtract residual echo from the combined signal. An integrator 180, may output the total power which may be looped back into the variable line impedance, thereby creating a variable input of the total power into differential amplifier 160. Such a feedback operation may be repeated by cycling the possible adjustable hybrid gain 140 settings to produce a received signal with the desired level (e.g. lowest) residual echo.

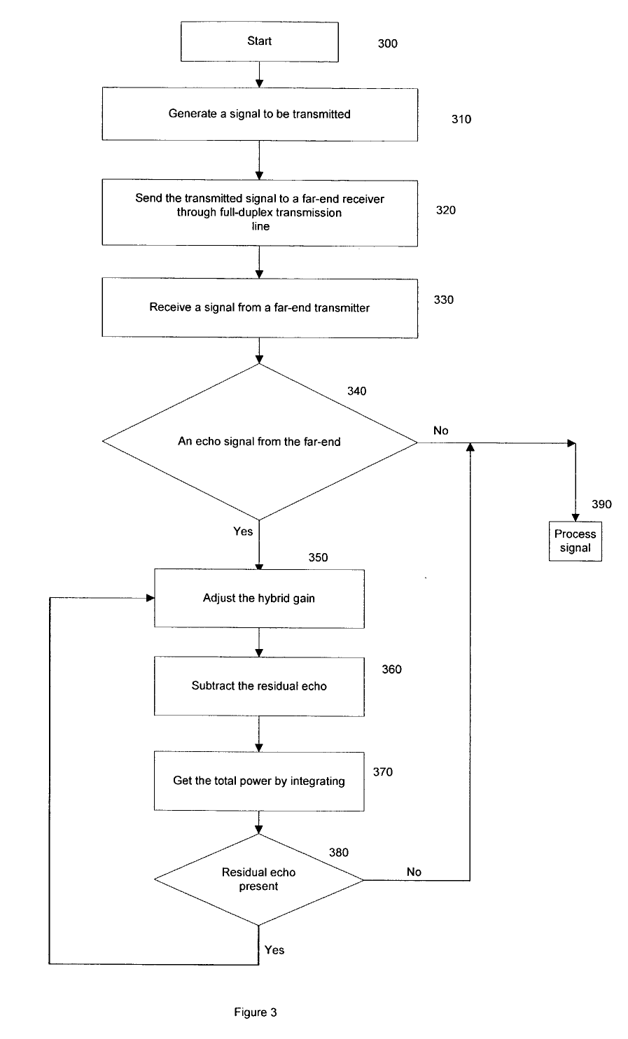

According to another embodiment, and in reference to FIG. 3, the process begins (e.g., at 300) and with a signal being generated for transmission in step 310. the transmitted signal is sent to a far-end receiver through a full-duplex transmission line in step 320. In step 330, a signal is received from a far-end transmitter. A portion of the transmitted signal may leak into or interfere with the receive path and hence, a check is made to identify if there is an echo present in the received signal in step 340. If no echo is present in the received signal, the signal is passed on to the signal processing portion of the receiver. If an echo is determined to be present in the received signal, the hybrid gain is adjusted in step 350 and the residual echo (e.g. the transmitted signal) is subtracted from the composite signal in step 360. The result of the subtraction step is integrated in order to calculate the total power in step 370. The total power, calculated in step 370, is checked for residual echo in step 380 and when it is determined that an echo is present, steps 350, 360, 370 and 380 are iteratively performed until all echo is removed or until the echo present in the received signal is minimized. After a predetermined number of iterations, the received signal is passed on to step 390 for processing.

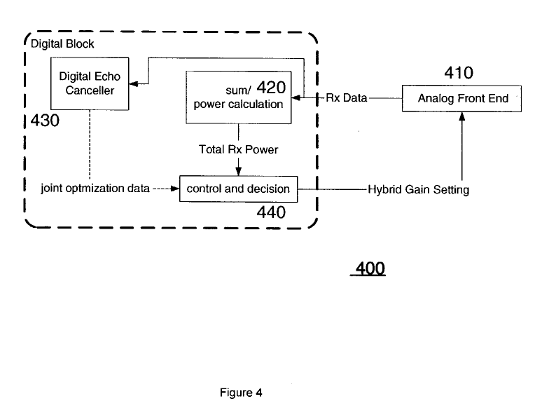

According to another embodiment, the invention may employ a digital block for making the hybrid gain setting decision by evaluating the hybrid performance where the total received power is measured. FIG. 4 shows a digital embodiment of an adjustable hybrid gain circuit. As shown, the received signal along with the residual echo is passed on to a digital echo canceller 430 to remove the echo. The received signal power and the residual echo power maybe summed together and the total power calculated by the summing and calculating block 420. The output of the digital echo canceller 430 as well as the output of the power summer/calculator 420 is sent to a digital control and decision block 440, which may compare the total power of the received signal to the echo-less received signal, and after a predetermined number of iterations, the digital control and decision block 440 chooses the hybrid gain setting that yields the minimum residual echo power.

While the invention has been described in conjunction with the preferred embodiments, it should be understood that modifications will become apparent to those of ordinary skill in the art and that such modifications are intended to be included within the scope of the invention and the following claims.

What we claim is:

1. A hybrid circuit for removing echo from a bidirectional transmit and receive path, comprising:
a hybrid gain adjusting device;
a differential amplifier; and
an integrator.

2. The hybrid circuit of claim 1, wherein the hybrid gain device is positioned in series with transmit path.

3. The hybrid circuit of claim 1, wherein the differential amplifier subtracts the transmitted signal from the received signal.

4. The hybrid circuit of claim 1, wherein the integrator calculates the total power.

5. The hybrid circuit of claim 1, wherein the hybrid gain device is a variable resistor.

6. The hybrid circuit of claim 1, wherein the hybrid gain device is adjusted by the output of the integrator.

7. The hybrid circuit of claim 1, wherein the integrator is a capacitor.

8. A method for removing echo from a bi-directional telephone line comprising the steps of:
creating an echo by sending the transmitted signal through the hybrid;
adding the echo to the received signal;
minimizing the total power of the combined transmitted and received signal by adjusting the gain in the hybrid path;
integrating the output of the differential amplifier; and
subtracting the transmitted signal from the received signal.

9. The method of claim 8, wherein the adjusting of the transmitted signal occurs prior to subtracted from the received signal.

10. The method of claim 8, wherein the differential amplifier subtracts the transmitted signal from the received signal.

11. The method of claim 8, wherein the step of integration calculates the total power.

12. The method of claim 8, wherein the transmitted signal adjustment is done by adjusting a variable resistor.

13. The method of claim 8, wherein the hybrid gain device is adjusted by the output of the integrator.

14. The method of claim 8, wherein the integrator is a capacitor.

15. A method for digitally removing echo from a bi-directional communication line comprising the steps of:
receiving a digital signal from a far-end transmitter;
summing a true power of the received signal with a power of a residual echo;
measuring the summed power;
measuring all hybrid gain settings;
measuring the echo power for each setting;
choosing the gain that yields the minimum echo power.

16. The method of claim 15, wherein the adjusting of the transmitted signal occurs prior to subtraction from the received signal.

17. The method of claim 15, wherein the differential amplifier subtracts the transmitted signal from the received signal.

18. The method of claim 15, wherein the step of integration calculates the total power.

19. The method of claim 15, wherein the transmitted signal adjustment is done by adjusting a variable resistor.

20. The method of claim 15, wherein the hybrid gain device is adjusted by the output of the integrator.

21. The method of claim 15, wherein the integrator is a capacitor.
